(19) United States
(12) Patent Application Publication
(10) Pub. No.: US 2006/0186697 A1
(43) Pub. Date: Aug. 24, 2006

(54) Rain diverter

(76) Inventor: Myron S. Whitcomb, Sturgis, MI (US)

Correspondence Address: FLYNN THIEL BOUTELL & TANIS, P.C., 2026 RAMBLING ROAD, KALAMAZOO, MI, 49008-1631, US

(21) Appl. No.: 11/062,991

(22) Filed: Feb. 22, 2005

(51) Int. Cl. B60R 15/00

(52) U.S. Cl. 296/163

(57) ABSTRACT

A rain diverter is configured for attachment to rain channels constructed on a recreational vehicle side wall, such as over door and window openings. The rain diverter attaches to the rain channels without the need for tools, generally at an end of each rain channel, and provides a route for water caught by the rain channel to be diverted away from the side of the recreational vehicle. By diverting the water away from the side of the vehicle, the rain diverter aids in preventing the formation of stains on the side of the vehicle.

### FIELD OF THE INVENTION

The invention relates to recreational vehicle accessories, and more specifically to water runoff control. In one of its aspects, the invention relates to rain diverters for directing rain away from the side of a recreational vehicle.

### BACKGROUND OF THE INVENTION

In the recreational vehicle (RV) field, it has become well known that as moisture collects on a recreational vehicle, whether it is rain water, dew, or air conditioner condensate, this moisture will run down the sides of the recreational vehicle and can leave unsightly streaks. These streaks are particularly noticeable at the outlets of rain gutters, such as are used along the side walls, or over door and window openings of the recreational vehicle, where the flow of rain water down the side of the vehicle is concentrated. This unsightly streaking costs the vehicle owner unnecessary expense in the form of chemical cleaners, and unreasonable time and effort in keeping the vehicle presentable. As recreational vehicles have become more expensive, and more people are “full-timing” it in their RV, owners are taking increased pride in the appearance of their vehicle, because it is their home and because the appearance has great influence on the market value of the RV.

Several methods for controlling moisture runoff have been proposed in the prior art. U.S. Pat. No. 5,865,498 to Grogan discloses a drain trough including a base with two side walls extending upwardly therefrom to define a drain channel for receiving rain water and solid debris. The drain trough is slidably engageable with an existing awning track protruding from a wall of a recreational vehicle via a suspension rod. The suspension rod laterally extends from a top of one of the side walls of the drain trough. This same side wall has a support foot laterally extending proximate the base. The combination of the suspension rod and support foot dispose the drain trough in an upright, functional attitude in order to prevent damage to the vehicle by dripping and accumulating rainwater and debris. The drain trough optionally includes a splice for interconnecting two drain trough sections, as well as an end cap for preventing rain and debris from exiting one end of the drain trough.

U.S. Pat. No. 5,899,523 to Richards et al. discloses a downwardly sloped rain-deflecting extruded PVC trim molding with an attachment system that consists of two insert prongs that engage into existing camping type recreational vehicle molding rails. A concave cross-section opening, extending inwardly from the insert prong side toward the downwardly sloped rain-deflection portion, allows clearance for the existing recreational vehicle molding attachment screws. It includes a caulking channel between the top edge of the downwardly sloped rain-deflecting slope and the existing recreational vehicle molding.

The prior art systems described can be effective for their intended use, but are best adapted for use in recreational vehicles that are stationary for longer periods of time, in that they are not well adapted to remain in place when the vehicle is in motion at highway speeds. The prior art systems are also specifically adapted to engage existing horizontal tracks mounted on the vehicle, such as those utilized for awnings.

In some instances when a recreational vehicle includes a dedicated rain gutter or channel system with an outlet, it has also been known to use a conventional clothespin to provide an extended drip edge from the outlet to draw water away from the side wall of the recreational vehicle. However, the clothespin does not remain secured well during movement of the vehicle.

It would be advantageous to provide a component adapted to cooperate with existing rain gutter systems, such as that found over and along a side wall of a recreational vehicle or over doors and windows of the recreational vehicle. It would be further advantageous to provide such a component that is easy to install and that is capable of remaining in place when the recreational vehicle is traveling at high speeds.

### BRIEF SUMMARY OF THE INVENTION

In order to minimize the disadvantages of the above-described arrangements, a rain diverter according to the invention is configured for attachment to rain channels constructed on a recreational vehicle side wall, such as over door and window openings. The rain diverter attaches to the rain channels without the need for tools, generally at an end of each rain channel, and provides a route for water caught by the rain channel to be diverted away from the side of the recreational vehicle. By diverting the water away from the side of the vehicle, the rain diverter aids in preventing the formation of stains on the side of the vehicle.

### BRIEF DESCRIPTION OF THE SEVERAL VIEWS OF THE DRAWINGS

The present invention will be more fully understood from the detailed description and the accompanying drawings, wherein:

FIG. 1 is a perspective view of a rain diverter according to the invention.

FIG. 2 is a side view of the rain diverter of FIG. 1 installed on a rain gutter.

FIG. 3 is a side view of a recreational vehicle with an installed rain diverter of FIGS. 1-2.

### DETAILED DESCRIPTION OF THE INVENTION

Certain terminology will be used in the following description for convenience in reference only and will not be limiting. The words “up”, “down”, “right” and left” will designate directions in the drawings to which reference is made. The words “in” and “out” will refer to directions toward and away from, respectively, the geometric center of the device and designated parts thereof. Such terminology will include derivatives and words of similar import.

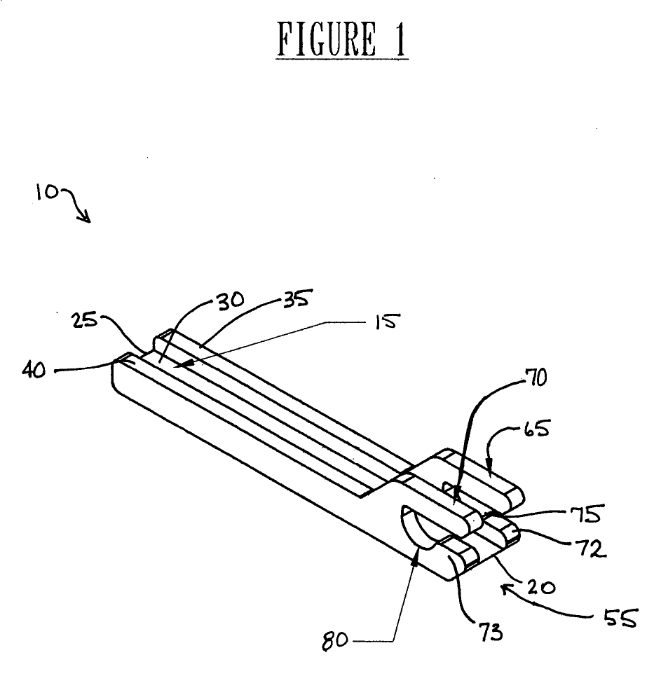

Referring to FIGS. 1-3, a rain diverter 10 according to the invention includes an elongate channel 15 having a proximal end 20 and a distal end 25. The channel 15 is integrally formed with a base 30 and two upstanding side walls 35, 40.

The proximal end 20 of the channel 15 of the rain diverter 10 is configured to attach to a rain channel or gutter 45 of a recreational vehicle 50. Each of the side walls 35, 40 of the diverter 10 includes at a respective proximal end a mounting arrangement 55. The mounting arrangement 55 is defined by an upper arm or lobe 65, 70 extending proximally from and generally parallel to the respective side wall 35, 40. Further, below each lobe 65, 70, each side wall 35, 40 defines a lower arm or lobe 72, 73, each of which is spaced downwardly from and is generally vertically aligned with the respective upper arm 65, 70. The spaces between the respective pairs of upper and lower arms define a catch 75, 80.

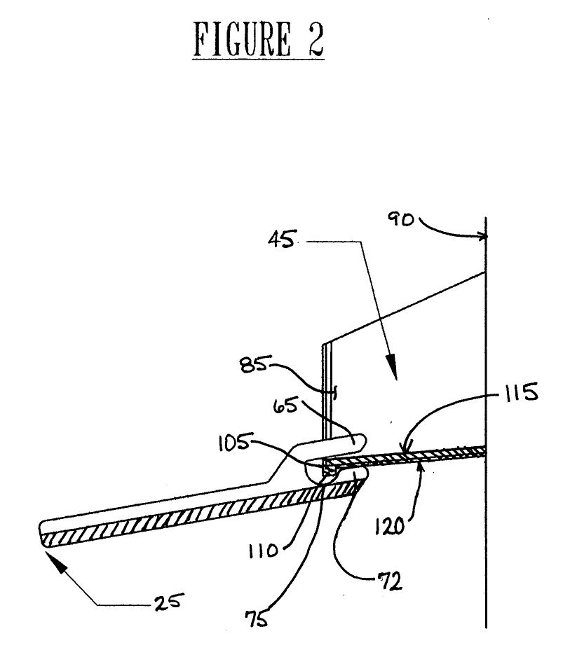

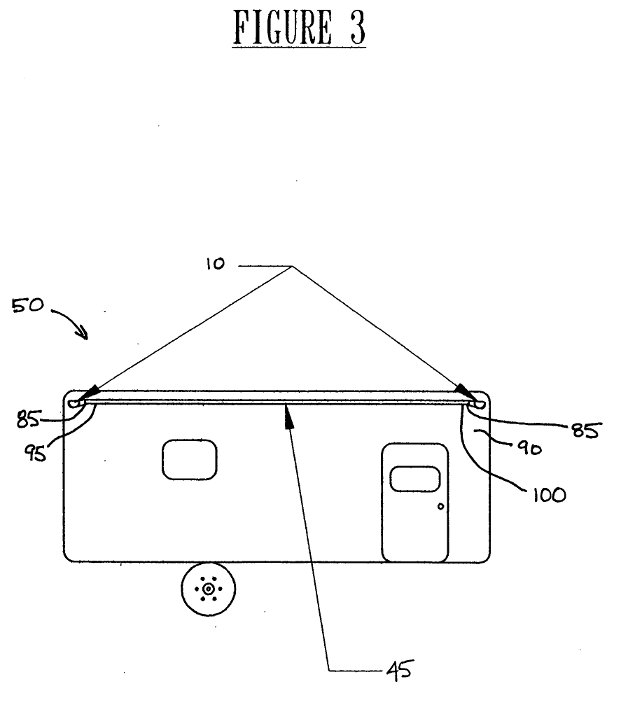

Referring now to FIGS. 2-3, the diverter 10 is configured for attachment to an outlet 85 of the rain gutter 45 mounted on a side wall 90 of the recreational vehicle 50. In FIG. 3, one diverter 10 is mounted at each end 95, 100 of the rain gutter 45.

As shown in FIG. 2, the diverter 10 is mounted to a distal lip 105 of the rain gutter 45. The distal lip 105 includes a downturned portion or flange 110. The diverter 10 is configured to engage the distal lip 105 of the rain gutter 45, as the downturned portion 110 is received by the indentation 75, 80 formed in the side wall 35, 40 of the diverter channel 15. The upper lobe 65, 70 is configured to bear against an interior bottom surface 115 of the rain gutter 45 at the distal lip 105, and the lower lobe 72, 73 bears against an exterior bottom surface 120 of gutter 45.

When in place, the diverter 10 is positioned on the rain gutter 45 at a low point, such as the outlet 85. As water flows in the rain gutter 45 to the outlet 85, the water will flow into the proximal end 20 of the channel 15 and flow through the channel 15 to its distal end 25. The water is thereby diverted away from the side wall 90 of the recreational vehicle 50.

Without the diverter 10 in place, the water would have a tendency to flow back along the bottom surface 120 of the rain gutter 45 and onto the side wall 90 of the recreational vehicle 50, leaving unsightly stains thereon. The rain diverter 10 according to the invention overcomes this disadvantage, and provides an affordable and expedient remedy to this otherwise costly and time consuming issue.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the scope of the appended claims.

What is claimed is:

1. A rain diverter comprising a channel and an attachment portion, the attachment portion being configured for attachment to a rain gutter mounted on the side of a recreational vehicle and the channel being configured to receive water from the rain gutter and direct it away from the side of the recreational vehicle.

2. The rain diverter according to claim 1, wherein the channel comprises a base and two side walls, and the attachment portion is integrally formed in at least one side wall.

3. The rain diverter according to claim 2, wherein the attachment portion comprises an arm portion extending parallel to the channel and a cutout portion in the at least one side wall.

4. A rain diverter for attachment to a rain gutter of a recreational vehicle, the rain diverter comprising:
an elongate channel having a proximal end and a distal end;
an attachment portion formed in the proximal end of the elongate channel, the attachment portion comprising an upper lobe integrally formed in a side wall of the channel and a recess formed in the side wall of the channel below the upper lobe,
wherein the upper lobe is configured to bear against an upper surface of the rain gutter and the side wall is configured to bear against a lower surface of the rain gutter.

5. The rain diverter according to claim 4, wherein the recess is configured to receive a downturned portion of the rain gutter.

6. A fluid diverter for attachment to a vehicle mounting thereon an elongate gutter along an upright side wall thereof which receives and redirects fluid such as rain therein, said diverter comprising:
an elongate base portion;
a pair of generally parallel and laterally-spaced side walls projecting upwardly from opposite longitudinal edges of said base portion, said base portion and the respective side walls together defining a generally upwardly opening and elongate channel for receiving fluid therein; and
a mounting arrangement disposed adjacent one end of said channel for securing said diverter to a gutter of a vehicle, said channel extending from adjacent said mounting arrangement in a direction away from a side wall of the vehicle so as to direct fluid flowing in a gutter of a vehicle away from a side wall thereof.

7. The fluid diverter according to claim 6, wherein said mounting arrangement is defined by upper and lower arms which are vertically spaced from one another so as to define therebetween an opening configured for receiving a portion of a gutter of a vehicle.

8. The fluid diverter according to claim 7, wherein said upper arm is defined by a pair of laterally-spaced upper arms which define extensions of the respective side walls, and said lower arm is defined by a pair of laterally-spaced lower arms which define extensions of the respective side walls, and said opening extends between said upper and lower arms.

9. The fluid diverter according to claim 8, wherein said upper arms are generally vertically aligned with the respective lower arms, and said opening includes a pair of horizontally aligned openings respectively defined between the respective pairs of upper and lower arms.
